(19) United States
(12) Patent Application Publication
(10) Pub. No.: US 2022/0379275 A1
(43) Pub. Date: Dec. 1, 2022

(54) APPARATUS FOR MIXING RESIN COMPOSITION FOR MANUFACTURING POLISHING PAD AND METHOD OF MANUFACTURING POLISHING PAD

(71) Applicant: SKC solmics Co., Ltd., Pyeongtaek-si (KR)

(72) Inventors: JUNG NAM LEE, Seoul (KR); Sunghoon YUN, Seoul (KR); Jangwon SEO, Seoul (KR); TAE KYOUNG KWON, Suwon-si (KR)

(73) Assignee: SKC solmics Co., Ltd., Pyeongtaek-si (KR)

(21) Appl. No.: 17/751,947

(22) Filed: May 24, 2022

(30) Foreign Application Priority Data
May 26, 2021 (KR) 10-2021-0067603

(51) Int. Cl. B01F 35/00; B29B 7/18; B29B 7/24; B29B 7/74; B01F 27/1142; B01F 27/1123

(52) U.S. Cl. CPC B01F 35/187; B29B 7/18; B29B 7/24; B29B 7/7433; B01F 27/1142; B01F 27/1123; B01F 2101/2805

(57) ABSTRACT

The present disclosure relates to an apparatus for mixing a resin composition for manufacturing a polishing pad including: a raw material mixer preparing a mixed raw material including a prepolymer and a foaming agent; a filter connected to the raw material mixer for filtering the mixed raw material; and a pad composition mixer connected to the filter to prepare a curable mixture including the mixed raw material after being filtered and a curing agent, wherein the raw material mixer includes a plurality of rotators having different rotation speeds.

### CROSS-REFERENCE TO RELATED APPLICATION

This application claims priority to Korean Patent Application No. 10-2021-0067603, filed on May 26, 2021, and all the benefits accruing therefrom under 35 U.S.C. § 119, the content of which in its entirety is herein incorporated by reference.

### BACKGROUND

### 1. Field

The present disclosure relates to a mixing apparatus of a resin composition for manufacturing a polishing pad, and a manufacturing method of a polishing pad.

### 2. Description of Related Art

Chemical Mechanical Polishing (CMP) process is a process for chemical-mechanical planation of uneven portions of a polishing target such as a wafer surface. For a wafer, the process is performed in the method of relatively moving a platen and a head while reacting the wafer surface to be chemically reacted by supplying slurry, when a polishing target is attached to the head and contacted to the surface of a polishing pad formed on the platen, in many cases.

The polishing layer included in a polishing pad is one of necessary raw materials serving as an important role in the chemical mechanical polishing process.

The polishing efficiency of the chemical mechanical polishing process, the quality of polished target, and the like were influenced by the apparatus of chemical mechanical polishing, the composition of slurry composition, the shape and properties of a polishing pad, and the like.

The polishing pad is manufactured from polyurethane in many cases. For example, the polyurethane may be manufactured by mixing a prepolymer, a foaming agent, a curing agent, and the like, put the mixture into a mold for operating curing reaction, and processed to be applied as a polishing pad.

### SUMMARY

In one general aspect, an apparatus for mixing a resin composition for manufacturing a polishing pad according to one embodiment includes: a raw material mixer preparing a mixed raw material including a prepolymer and a foaming agent; a filter connected to the raw material mixer for filtering the mixed raw material; and a pad composition mixer connected to the filter to prepare a curable mixture including the mixed raw material after being filtered and a curing agent.

The raw material mixer may include a plurality of rotators having different rotation speeds.

The filter may include a first filter for filtering the mixed raw material depending on a size of the mixed raw material.

The filter may include a second filter for separating metallic matters from the mixed raw material.

The first filter may include a first filter housing, in which the mixed raw material moves; and a filtering wall disposed in the filter housing, through which the mixed raw material passes.

The filtering wall may allow the mixed raw material in a predetermined size or less to be passed.

The second filter may include a second filter housing, in which the mixed raw material passes; a holder disposed in the second filter housing and in contact with the mixed raw material passing therethrough; and a magnet disposed in an inner portion of the holder and generating a magnetic power.

The metallic matters may be attached to an outer circumference of the holder by the magnetic power and thereby removed from the mixed raw material.

In an inner portion of the second filter housing, a filter space, in which the holder is located, may be disposed.

In an outer circumference of the lower portion of the second filter housing, an inlet to which the mixed raw material is introduced to the filter space, may be disposed in a tangent direction of the outer circumference.

In the outer circumference of an upper portion of the second filter housing, an outlet for emitting the mixed raw material, which is separated from the metallic matters after passing through the filter space, may be disposed.

The outlet may be arranged side by side with the tangent direction of the outer circumference.

The inlet and the outlet may face together in an opposite angle having the holder therebetween.

The second filter may further include a cover combined with the second filter housing to be separatable and connected to the holder.

The raw material mixer may include a mixing container, in which a raw material mixing space is disposed; and a raw material stirrer disposed in the raw material mixing space and may be moved by the plurality of rotators.

The raw material mixer may mix the prepolymer and the foaming agent, accommodated in the raw material mixing space, and may disperse the foaming agent in the mixed raw material.

The plurality of rotators may include a first operating component and at least one second operating component.

The raw material mixer may include a rotating body connected to the first operating component to be rotatable, in which the at least one second operating component is disposed; and at least one raw material mixing component connected to the at least one second operating component to be rotatable.

The at least one raw material mixing component may be rotated by the at least one second operating component.

The raw material mixing component may include a shaft connected to an operating axis of the at least one second operating component; and a stirring blade accommodated in the raw material mixing space.

The stirring blade may include a helical type stirring blade.

The pad composition mixer may include a composition mixing container, in which a composition mixing space is disposed; and a composition mixing component disposed in the composition mixing container.

The composition mixing component mixes the mixed raw material and the curing agent to prepare a curable mixture. The mixed raw material may be a mixed raw material filtered by passing through the filter.

The composition mixing component may include a motor; a shaft connected to an operating axis of the motor; and a stirring blade connected to the shaft and mixing the mixed raw material and the curing agent accommodated in the composition mixing space.

The apparatus for mixing of a resin composition for manufacturing a polishing pad may further include a uniformizer to increase a dispersion degree of the mixed raw material emitted from the raw material mixer.

The uniformizer may include a uniformizing housing having an inlet and an outlet; a rotor disposed in the uniformizing housing to be rotatable; and a motor connected to the uniformizing housing and rotating the rotor.

The uniformizer may include a uniformizing housing having an inlet and an outlet; a shaft disposed in the uniformizing housing to be rotatable; and a uniformizing plate arranged along a length direction of the shaft with flowing holes formed thereon.

The flowing holes of neighboring uniformizing plates may be out of joint.

An apparatus for mixing of a resin composition for manufacturing a polishing pad according to another embodiment includes, a raw material mixer preparing a mixed raw material including a prepolymer and a foaming agent; a filter connected to the raw material mixer for filtering the mixed raw material; and a pad composition mixer connected to the filter and prepares a curable mixture including the mixed raw material after being filtered and a curing agent.

The raw material mixer may include a raw material mixing container, in which a raw material mixing space is disposed; a shaft connected to an operating axis of an operator and disposed in the raw material mixing space; and a stirring blade connected to the shaft and rotating.

The stirring blade may mix the prepolymer and the foaming agent supplied to the raw material mixing space and may disperse the foaming agent in the mixed raw material while rotating.

The filter may include a first filter for filtering the mixed raw material depending on a size of the mixed raw material.

The filter may include a second filter for separating metallic matters from the mixed raw material.

A method for of manufacturing a polishing pad according to another embodiment may include: filtering a mixed raw material including a prepolymer and a foaming agent to prepare a mixed raw material after being filtered; preparing a curable mixture including the mixed raw material after being filtered and a curing agent; and putting the curable mixture into a mold and preparing a shaped body, thereby manufacturing a polishing pad including at least some of the shaped body as a polishing layer.

The filtering may include a filtering process to which a magnetic filter is applied.

The foaming agent may include a solid foaming agent, and the solid foaming agent may be one classified and refined.

The foaming agent may include a solid foaming agent having a moisture regain of 3 wt % or less.

Other features and aspects will be apparent from the following detailed description, the drawings, and the claims.

### BRIEF DESCRIPTION OF THE DRAWINGS

FIG. 1 is a schematic view for showing a mixing apparatus of a resin composition for manufacturing a polishing pad according to one embodiment.

FIG. 2 is an enlarged view for showing a raw material mixing unit of FIG. 1.

FIG. 3 is a schematic view for showing a first filter unit of FIG. 1.

FIG. 4 is a schematic view for showing a second filter unit of FIG. 1.

FIG. 5 is an exploded view of FIG. 4.

FIG. 6 is a schematic view for showing a mixing apparatus of a resin composition for manufacturing a polishing pad according to another embodiment.

FIG. 7 is a schematic view for showing a uniformizing unit of FIG. 6.

FIG. 8 is a schematic view for showing a mixing apparatus for a resin composition for manufacturing a polishing pad of another embodiment.

FIG. 9 is a schematic view for showing a uniformizing unit of FIG. 8.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

Hereinafter, example embodiments of the present disclosure will be described in detail with reference to the accompanying drawings so that they can be easily practiced by those skilled in the art to which the present invention pertains. However, the example embodiments may be embodied in many different forms and is not to be construed as being limited to the embodiments set forth herein. Like reference numerals designate like elements throughout the specification.

In this application, the term for degree like “about”, “substantially” and the like is used for meaning values approximative from/to the value when a tolerance to be proper to referred meaning for manufacture and substance is presented. Additionally, these terms for degree are used to help understanding of example embodiments and to prevent that an unconscionable trespasser unjustly uses the presented content in which exact or absolute number is referred.

Throughout this application, the phrase “combination(s) thereof” included in a Markush-type expression denotes one or more mixtures or combinations selected from the group consisting of components stated in the Markush-type expression, that is, denotes one or more components selected from the group consisting of the components are included.

Throughout this application, the description of “A and/or B” means “A, B, or A and B.”

Throughout this application, terms such as “first”, “second”, “A”, or “B” are used to distinguish the same terms from each other unless specially stated otherwise.

In this application, “B being placed on A” means that B is placed in direct contact with A or placed over A with another layer or structure interposed therebetween and thus should not be interpreted as being limited to B being placed in direct contact with A.

In this application, a singular form is contextually interpreted as including a plural form as well as a singular form unless specially stated otherwise.

In this application, the size of each component of drawings may be exaggerated for description of the present disclosure, and may be different from the size to be actually applied.

A polishing pad comprises a polishing layer in the shape of a foamed body having hollows and elasticity. A foaming agent and a resin composition are applied to the manufacture of the polishing layer.

For further accurately controlling the diameter of hollows, a solid foaming agent is applied. It is not easy to disperse a foaming agent in a powder form into a liquid polymer resin to be completely uniform. When the liquid polymer resin has a viscosity of a certain level or more, the dispersion is more difficult.

The present disclosure provides technology which can efficiently mix raw materials for manufacture of a polishing pad, and can remove metallic foreign matter contained in the raw material during a mixing process for the raw material.

The inventors have ascertained that at least some of the solid foaming agent is easy to cohere and to be present in a mixed raw material as an aggregate, in this time, the aggregate with a relatively large size makes influences in a polishing pad such as functioning like foreign matters and changing the movement of slurry during polishing, and this influences not only the quality of the polishing pad but also the polishing quality of a polished target.

The inventors have ascertained that impurities infiltrated unintentionally in processes for manufacturing a polishing pad may greatly affect the quality of a polished target, and metallic matters as one example are one of the reasons generating a scratch and the like in the polished target.

Accordingly, the inventors have conducted research on the method of efficiently manufacturing a polishing pad and the method for improving the properties of the manufactured polishing pad and a polished target polished by the same, and disclosed example embodiments described below.

According to example embodiments, through a mixing apparatus of a resin composition for manufacturing a polishing pad, mixing and dispersing processes for a resin composition for manufacturing a polishing pad are controlled and thereby a curable mixture substantially uniform and controlled in the infiltration of foreign matters can be prepared. Besides, when a polishing pad is manufactured by using the above, the degradation of the properties of a polishing pad caused from defects of a curable mixture can be reduced and furthermore, the polishing quality of a polished target (e.g., wafer) polished by the polishing pad can be improved.

(Mixing Apparatus of Resin Composition for Manufacturing Polishing Pad)

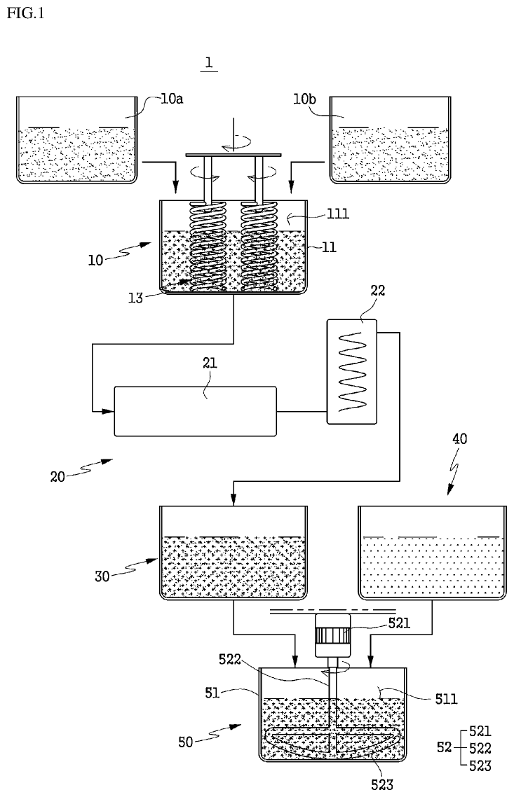

Descriptions will be made on a mixing apparatus of a resin composition for manufacturing a polishing pad according to one embodiment with reference to FIG. 1 to FIG. 5.

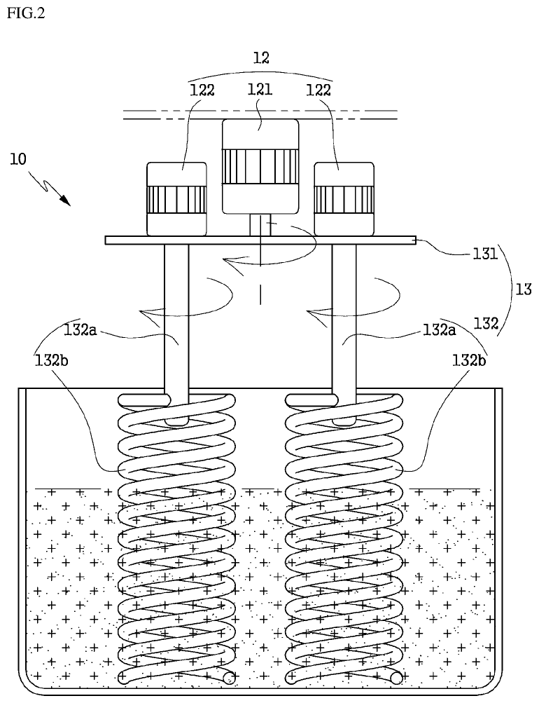

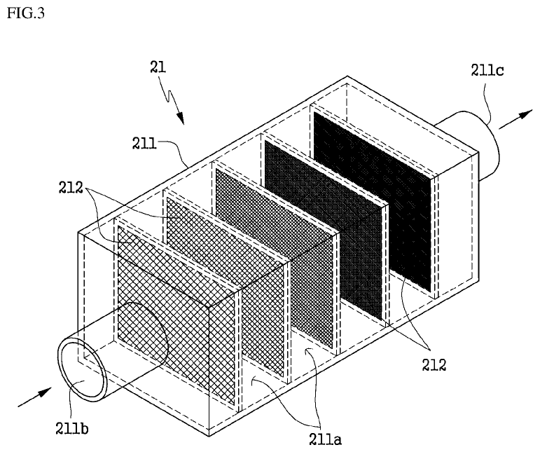

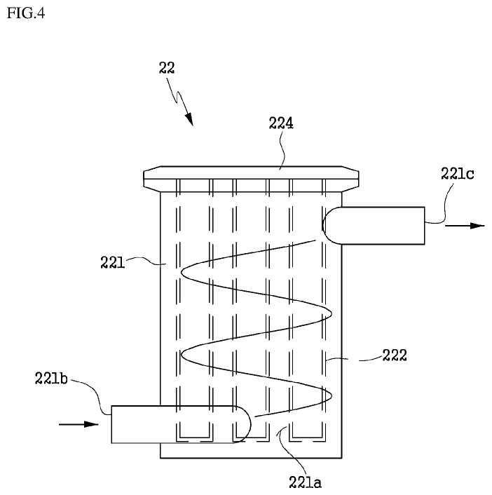

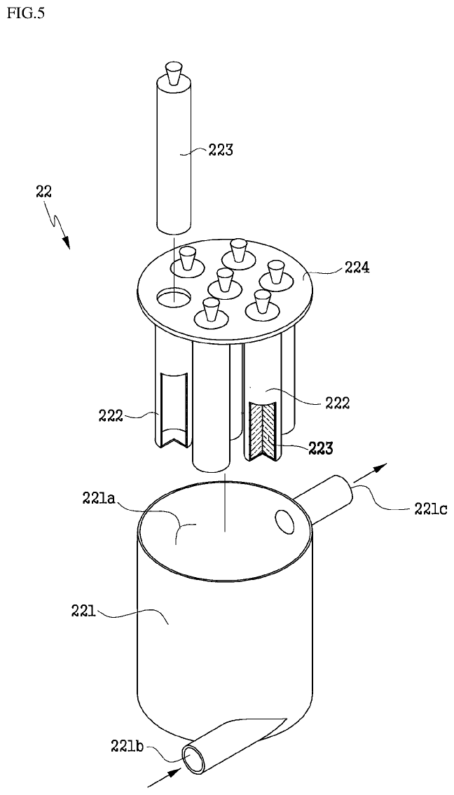

FIG. 1 is a schematic view for showing a mixing apparatus of a resin composition for manufacturing a polishing pad according to one embodiment, FIG. 2 is an enlarged view for showing a raw material mixing unit of FIG. 1, FIG. 3 is a schematic view for showing a first filter unit of FIG. 1, FIG. 4 is a schematic view for showing a second filter unit of FIG. 1, and FIG. 5 is an exploded view of FIG. 4.

With reference to FIG. 1 to FIG. 5, a mixing apparatus of a resin composition for manufacturing a polishing pad according to embodiments (1) comprises a raw material mixing unit 10 preparing a mixed raw material comprising a prepolymer and a foaming agent; a filter unit 20 connected to the raw material mixing unit 10 for filtering the mixed raw material; and a pad composition forming unit 50 connected to the filter unit 20 and prepares a curable mixture comprising a mixed raw material after being filtered and a curing agent.

A mixing apparatus of a resin composition for manufacturing a polishing pad according to another embodiment has most of components of embodiments described with reference to FIG. 1 to FIG. 7 disclosed in the follows.

The raw material mixing unit 10 of embodiments comprises at least one operating unit (not shown) comprising at least one motor.

The operating unit rotates with being connected to a shaft (now shown), and a stirring blade (not shown) mixes a prepolymer and a foaming agent rotated and supplied by the shaft in the inside of a raw material mixing container 11.

The mixed raw material can be uniformized for the particles when passing through uniformizing units 60 and 70, and can maintain the predetermined size and separate metallic matters when passing through a filter unit 20.

(Mixing Unit for Raw Material: Arrangement Type)

The raw material mixing unit 10 comprises a raw material mixing container 11 having a raw material mixing space 111 is arranged therein; a raw material mixing mean 13 disposed in the raw material mixing space 111 to be moved by multiple rotation means 12; and multiple rotation means 12 having different rotation speeds and allowing the raw material mixing mean 13 to be moved.

The raw material mixing container 11 may be connected to a first supplying unit 10a for supplying a prepolymer, and a second supplying unit 10b for supplying a foaming agent. The prepolymer and foaming agent respectively supplied from the first supplying unit 18a and second supplying unit 10b may be accommodated in the raw material mixing space of the raw material container 11.

In the raw material mixing space 111, a pump (now shown) for sending a mixed raw material prepared by mixture of a prepolymer and a foaming agent may be disposed. In the raw material mixing space 111, a blower for sending a mixed raw material prepared by mixture of a prepolymer and a foaming agent may be disposed. Depending on the state of the mixed raw material (solution or powder), the pump and blower may be selectively applied.

The prepolymer means a polymer resin having a lower molecular weight compared to the final shaped product whose polymerization is maintained to be an intermediate degree. The prepolymer can be shaped by itself or after being reacted with other polymeric compounds, and usually applied in a liquid form.

The liquid prepolymer may comprise any one selected from the group consisting of polyurethane, polysulfone, polyether sulfone, nylon, polyether, polyester, polystyrene, polyolefin, epoxy, silicone, and combinations thereof, and may be a prepolymer forming polyurethane.

The prepolymer may be a prepolymer in which an isocyanate compound and polyol are reacted. For example, an isocyanate compound, polyol, and a prepolymer manufactured from the isocyanate and the polyol may be applied.

The isocyanate compound used in the manufacture of an urethane-based prepolymer may be for example, one or more isocyanates selected from the group consisting of toluene diisocyanate (TDI), naphthalene-1,5-diisocyanate, p-phenylene diisocyanate, tolidine diisocyanate, 4,4′-diphenyl methane diisocyanate, hexamethylene diisocyanate, dicyclohexylmethane diisocyanate, and isoporone diisocyanate.

The polyol which can be used in the manufacture of an urethane-based prepolymer may be for example, one or more polyols selected from the group consisting of polyether polyols, polyester polyols, polycarbonate polyols, and acryl polyols. The polyol may have a weight average molecular weight (Mw) of 300 to 3,000 g/mol.

The urethane-based prepolymer may be a polymer in which toluene diisocyanate (TDI) is used as an isocyanate-based compound and polytetramethylene ether glycol is used as a polyol to be polymerized and to have a weight average molecular weight (Mw) of 500 to 3,000 g/mol.

A shaped body or a polishing layer which is the final shaped product may be a foamed body having pores (hollows).

The pores are present in the state of being dispersed in the shaped polyurethane resin. The pores may formed by bubbles formed through a micro capsule thermally expanded as a solid foaming agent or formed by applying an inert gas.

The foaming agent comprises a solid foaming agent. The solid foaming agent may be a micro balloon structure which is a thermally expanded (regulated in the size) micro capsule and has an average diameter of 5 to 200 μm. The thermally expanded (regulated in the size) micro capsule may be one obtained by heating and expanding a thermally expanded micro capsule.

The thermally expanded micro capsule may have a density of 100 kg/m³ or less, or a density of 80 kg/m³ or less. Also, the thermally expanded micro capsule may have a density of 10 to 80 kg/m³, or a density of 10 to 60 kg/m³.

The thermally expanded micro capsule may have a skin comprising a thermoplastic resin and a foaming agent embedded with being sealed in the skin. The thermoplastic resin may be one or more selected from the group consisting of vylidene chloride-based copolymers, acrylonitrile-based copolymers, methacrylonitrile-based copolymers, and acrylic copolymers. Furthermore, the foaming agent embedded with being sealed in the inside may be one or more selected from the group consisting of hydrocarbon having one to seven carbons.

The foaming agent embedded with being sealed in the thermally expanding micro capsule may be selected from the group consisting of low molecular hydrocarbons such as ethane, ethylene, propane, propene, n-butane, isobutene, butene, isobutene, n-pentane, isopentane, neopentane, n-hexane, heptane, and petroleum ether; chlorofluoro hydrocarbons such as trichlorofluoromethane (CCl₃F), dichlorodifluoromethane (CCl₂F₂), chlorotrifluoromethane (CClF₃), and tetrafluoroethylene (CClF₂—CClF₂); and tetraalkylsilanes such as tetramethylsilane, trimethylethylsilane, trimethylisopropylsilane, and trimethyl-n-propylsilane.

The foaming agent may be differently applied depending on the ratio of pores desired to be applied. In detail, the foaming agent may be applied in an amount of 0.5 to 40 parts by weight, 1 to 35 parts by weight, or 5 to 30 parts by weight based on a prepolymer of 100 parts by weight.

The mixed raw material may further comprise a surfactant as needed. The surfactant lowers the surface tension of the mixed raw material thereby improving miscibility and helps the sizes of bubbles that may be generated in a mixing process to be relatively uniform. The surfactant may be for example, a surface active agent may be applied. The surfactant may be applied in an amount of 0.1 to 5 parts by weight based on a prepolymer of 100 parts by weight.

The raw material mixing mean 13 comprises a rotating body 131 connected to a rotation mean 12 to be rotatable; and at least one or more raw material mixing components 132 located in a raw material mixing space 111 and connected to the rotating body 131 to be rotatable.

The rotation mean 12 and the rotating body 131 may be arranged in the raw material mixing space 111. The rotation mean 12 and the rotating body may be arranged in the external of the raw material mixing space 111.

The rotation mean 12 may be disposed on the raw material container 11.

The rotating body 131 may be disposed on the raw material container 11.

The multiple rotation means 12 comprise a first operating component 121 and a second operating component 122.

The first operating component 121 may be connected to a rotating body 131 and rotate the rotating body 131.

One, two, or more second operating components 122 may be arranged on the rotating body 131.

The first operating component 121 may rotate in a different speed and/or different direction from the second operating component 122 and thereby can control rotating movement of the raw material mixed material. Through the above, the occurrence of a warm current is induced in the mixed raw material disposed in the raw material mixing space 111 and the uniformizing of the mixed raw material can be further efficiently induced.

The first operating component 121 may be connected to the rotating body 131. The first operating component 121 can rotate the rotating body 131.

The second operating component 122 may be connected to the rotating body 131. The second operating component 122 may be disposed on the rotating body 131. Two or more second operating components 122 may be arranged on the rotating body 131, and two to nine components may be arranged. Two or more raw material mixing component 132 may be respectively arranged not to interference one another.

The raw material mixing component 132 may be connected to the second operating component 122 and simultaneously allow the revolution operated by a rotating body 131 (first spin as revolution) and rotation operated by the second operating component 122 (second spin as rotation). The first spin (revolution) and the second spin (rotation) may be opposite in the direction of spins.

The multiple rotation mean 12 comprises a first operating component 121 connected to the rotating body 131 and rotating the rotating body 131; and at least one second operating component 122 disposed in the rotating body 131.

At least one second operating component 122 may be arranged along the circumference direction of the rotating body 131 based on the first operating component 121. The second operating component 122 was illustrated as applied with the number of 2 in drawings, but the number of the second operating component 122 may be changed depending on the design of a mixing apparatus for a resin composition for manufacturing a polishing pad.

The first operating component 121 and the second operating component 122 comprise noticed motors, and the rotation speeds of the first operating component 121 and the second operating component 122 may be the same and different from each other.

The rotation speed of the first operating component 121 may be 50 to 3000 rpm. The rotation speed of the first operating component 121 may be 80 to 2000 rpm. The rotation speed of the first operating component 121 may be 80 to 500 rpm.

The rotation speed of the second operating component 122 may be 50 to 3000 rpm. The rotation speed of the second operating component 122 may be 80 to 2500 rpm. The rotation speed of the second operating component 122 may be 80 to 2200 rpm.

The ratio of the rotation speed of the first operating component 121 to the rotation speed of the second operating component 122 may be 1:0.1 to 40. The ratio of the rotation speed of the first operating component 121 to the rotation speed of the second operating component may be 1:0.8 to 30. The rotation speed of the first operating component 121 to the rotation speed of the second operating component may be 1:8 to 28. The ratio of the rotation speed of the first operating component 121 to the rotation speed of the second operating component may be 1:15 to 25. When the rotation speed is controlled in such a range to rotate the first operating component 121 and the second operating component 122, thereby preparing a mixed raw material, the mixed raw material which is substantially uniform and in which aggregates of a cohered solid foaming agent are decreased can be prepared.

The viscosity measured at 70° C. may be 1000 cps or more, 1000 or 2300 cps, or 1000 to 2000 cps. The raw material mixing unit can disperse and uniformize the mixed raw material having the above viscosity range.

The rotating body 131 rotates on an operating axis (not shown) of the first operating component 121 in the upper position of the raw material mixing container 11, through operation of the first operating component 121. Besides, the rotating body 131 may ascend and descend through an ascending and descending unit such as an actuator, an electric cylinder, and the like. The second operating component 122 may be moved along the circumference direction based on the first operating component 121 by a rotating body 131.

At least one raw material mixing component 132 is connected to at least one second operating component 122. Accordingly, at least one raw material mixing component 132 is rotated by at least one second operating component 122 and simultaneously moves along the rotating body 131. The number of the raw material mixing component 132 may be applied as the same as the number of the second operating component 122.

The raw material mixing component 132 comprises a shaft 132a located in a raw material mixing space 111 and connected to an operating axis of the second operating component 122 to be rotatable; and a stirring blade connected to the shaft 132a and mixing the prepolymer and foaming agent accommodated in the raw material mixing space 111. The raw material mixing component 132 is rotated by the second operating component 122 and moved by the rotating body 131, and thereby can mix the prepolymer and foaming agent of the raw material mixing space 111. The raw material mixing component 132 is rotated by the second operating component 122 and moved along the circumference direction of the raw material container 11 by the rotating body 131, and thereby can mix the prepolymer and foaming agent of the raw material mixing space 111.

The raw material mixing component 132 has a stirring blade. The stirring blade may have the shape of a paddle type, a turbine type, a propeller type, an anchor type or a helical type. Applying a helical type stirring blade may be advantageous to the efficiency of mixing.

The raw material mixing unit can efficiently prepare a mixed raw material substantially uniformized by applying two or more operating components and two or more raw material mixing components.

A raw material mixing mean, operated by multiple rotation means in the raw material mixing unit, can efficiently manufacture a mixed raw material in which a solid foaming agent in an ordinary solid powder form is improved in the aggregation thereof and a foaming agent is relatively uniformly dispersed in a liquid prepolymer, while rotating for efficiently mixing and uniformizing the mixed raw material in the raw material mixing container.

(Mixing Unit for Raw Material: In Line type)

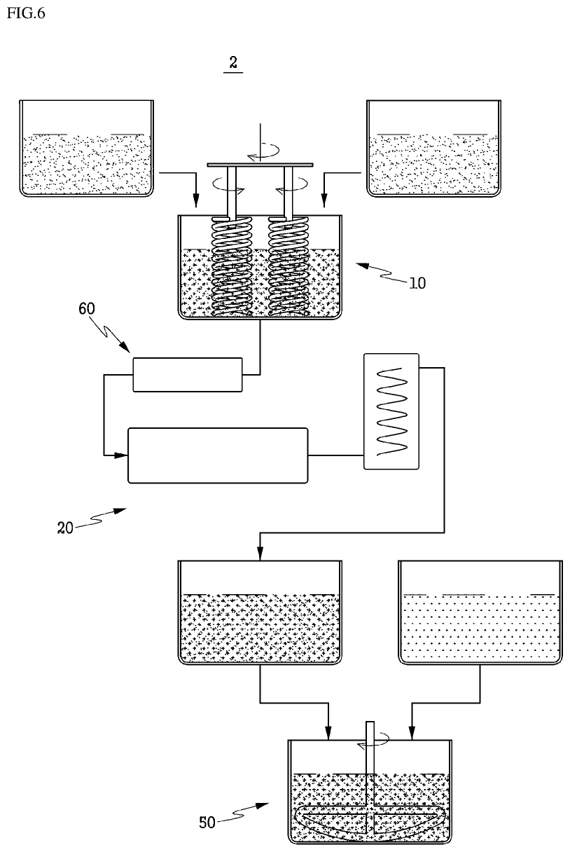

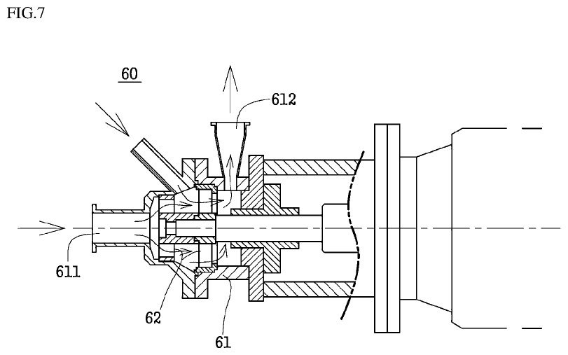

With reference to FIG. 6 and FIG. 7, the description of a mixing apparatus for a resin composition for manufacturing a polishing pad according to another embodiment will be made.

FIG. 6 is a schematic view for showing a mixing apparatus of a resin composition for manufacturing a polishing pad according to the embodiment, and FIG. 7 is a schematic view for showing a uniformizing unit of FIG. 6.

With reference to FIG. 6 and FIG. 7, a mixing apparatus of a resin composition for manufacturing a polishing pad 2 comprises a raw material mixing unit 10; a uniformizing unit 60; a filter unit 20; and a pad composition forming unit 50.

The raw material mixing unit 10, a filter unit 20, and a pad composition forming unit 50 according to the embodiment are the same as the raw material mixing unit, filter unit, and pad composition forming unit according to example embodiments of FIG. 1 to FIG. 5 and thus the overlapped description is omitted.

The uniformizing unit 60 is located between the raw material mixing unit 10 and the filter unit 20 and heightens the dispersion degree of the mixed raw material comprising aggregates to be greater than the mixed raw material before passing through the uniformizing unit to uniformize the mixed raw material substantially. The aggregates may be formed by cohered solid matters in some of the solid foaming agent comprised in the mixed raw material, during a process of mixing the foaming agent with a liquid prepolymer.

The uniformizing unit 60 may comprise a uniformizing housing 61 having an inlet 611 and an outlet 612, a rotor 62 disposed in the uniformizing housing 61 to be rotatable, and a motor 53 connected with the uniformizing housing 61 and rotating the rotor 62.

The rotor 62 allows the mixed raw material introduced into the uniformizing housing 61 through the inlet 611 to flow while being rotated by a motor in the uniformizing housing 61 and thereby can crush aggregation.

Various characteristics viewed in example embodiments illustrated in FIG. 1 to FIG. 5 may be applied to the present disclosure.

(Mixing Unit for Raw Material: Poly Mix Type)

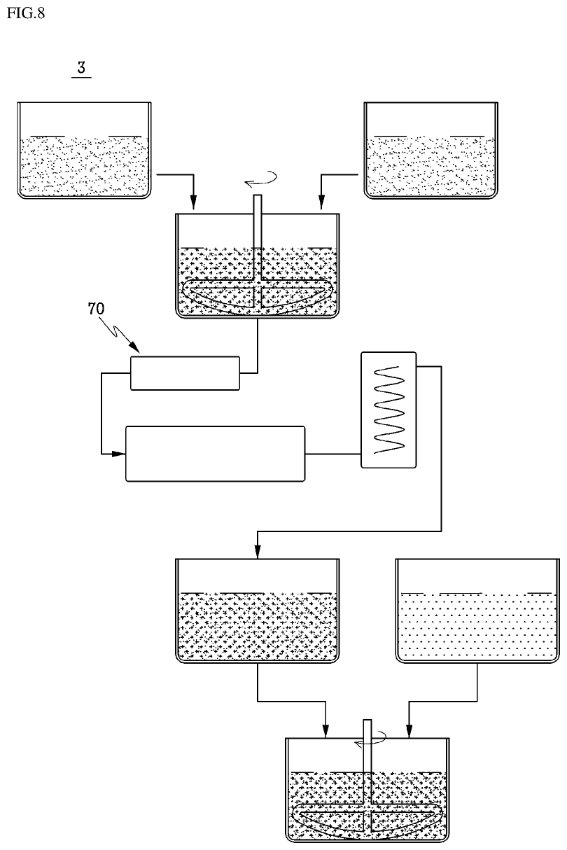

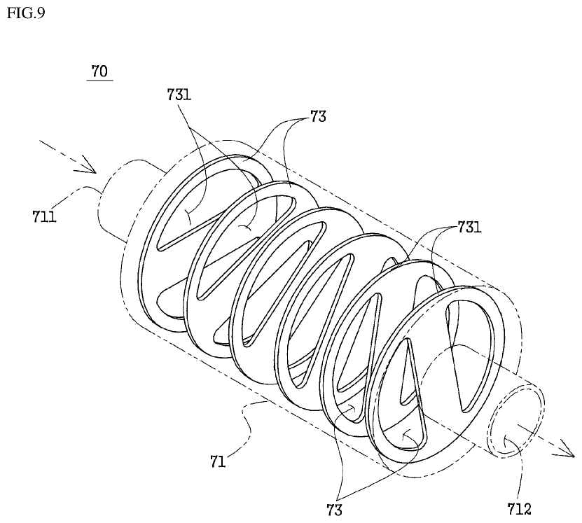

With reference to FIG. 8 and FIG. 9, the description of a mixing apparatus of a resin composition for manufacturing a polishing pad according to another embodiment will be made.

FIG. 8 is a schematic view for showing a mixing apparatus of a resin composition for manufacturing a polishing pad according to embodiments, and FIG. 9 is a schematic view for the uniformizing unit of FIG. 8.

The mixing apparatus of a resin composition for manufacturing a polishing pad according to the embodiment has most of components of example embodiments described with reference to FIG. 1 to FIG. 5 or FIG. 6 to FIG. 7. However, the uniformizing unit 70 of the embodiment has a different structure from the uniformizing unit according to embodiments of FIG. 6 to FIG. 7.

With reference to FIG. 8 and FIG. 9, a uniformizing unit 70 of the mixing apparatus of a resin composition for manufacturing a polishing pad 3 comprises a uniformizing housing 71 having an inlet 711 and an outlet 712, a shaft (not shown) connected to a motor (now shown) under power and disposed in the uniformizing housing 71 to be rotatable, and a uniformizing plate 73 arranged along the length direction of the shaft and in which a flow hole 731 is formed. The flow hole 731 is formed in a multiple number with intervals along the circumference direction of the uniformizing plate 73.

Neighboring uniformizing plates 73 may be arranged to have flow holes 731 located to be out of joint from one another. The uniformizing plates 73 may be arranged in the predetermined angle from the shaft to be sloped, for pushing the mixed raw material introduced into the uniformizing housing 71 through an inlet 711, to the direction of the outlet 712.

The mixed raw material introduced into the inlet 711 may be uniformized in a method similar to crush while passing through the flow holes 731 of the rotating uniformizing plates 73. That is, aggregates in the mixed raw material flowing in the uniformizing housing 71 are crushed by the rotating plates 73 and dispersed in the mixed raw material, thereby being substantially uniformized.

(Filter Unit)

The filter unit 20 may be disposed in a moving route of the mixed raw material emitted from the raw material mixing container 11. The filter unit 20 comprises a second filter unit 22 for separating metallic matters from the mixed raw material. The filter unit 20 may comprise a first filter unit 21; and a second filter unit 22 which separates metallic matters from the mixed raw material which has passed the first filter unit 21.

The mixed raw material comprises a prepolymer and a foaming agent, and the foaming agent is applied by a solid foaming agent. The solid foaming agent in a powder form may be mixed with a liquid prepolymer in the mixed raw material, and in the mixing process, aggregation of powder may partially occur. The first filter unit 21 can classify the foaming agent present in a solid form and other solid foreign matters from the liquid mixed raw material by the size and can remove them.

The first filter unit 21 comprises a filter housing 211 in which the mixed raw material emitted from the raw material mixing container 11 moves; and a filter member 212 disposed in the filter housing 211 for only passing the mixed raw material with a predetermined size or less from the mixed raw material in the filter housing 211.

On the inside of the filter housing 211, a filter space 211a is disposed in which the filter member 212 are disposed and a mixed raw material moves.

The filter housing 211 may have a horizontal length longer than the vertical length thereof. The mixed raw material may be moved along the horizontal length direction of the filter housing 211.

The filter housing 211 may have a vertical length longer than the horizontal length thereof. The mixed raw material may be moved along the vertical length direction of the filter housing 211.

The filter housing 211 may comprise an inlet 211b to which a mixed raw material is introduced, and an outlet 211c to which the mixed raw material is emitted after passing through the filter member 212.

On one side of the filter housing 211, the inlet 211b to which the raw material is introduced may be formed, and the outlet 211c to which the mixed raw material after passing through the filter member 212 may be formed on the other side of the filter housing 211.

The inlet 211b and the outlet 211c may face from each other in a substantially identical line.

The outlet 211c may be arranged lower than the inlet 211b.

The filter member 212 may comprise a single mesh material or multiple mesh materials.

The filter member 212 is located on the inside of the filter housing 211 and may be arranged to have an angle of more than 0 degree and less than 90 degrees, based on the movement direction of the mixed raw material from the inlet 211b to the outlet 211c. The filter member 212 is located on the inside of the filter housing 211 and may be arranged to have an angle of more than 45 degrees and less than 90 degrees, based on the movement direction of the mixed raw material from the inlet 211b to the outlet 211c.

The outline of the filter member is in contact of the inner circumference of the filter housing 211. Accordingly, the mixed raw material does not pass between the filter member 212 and the inner circumference of the filter housing 211. The mesh material may be made from a metal or a fabric.

The diameters of holes are respectively different in the mesh materials. The filter member 212 may be mesh materials with 50 to 300 mesh.

The filter member 212 may be mesh materials with 50 to 300 mesh.

The filter member 212 may be materials in the mesh form different in the size and arranged in order along the movement direction of a mixed raw material. When the filter member 212 comprises multiple components, the components may be arranged in order from one with smaller mesh to one with greater mesh. In this time, lumps formed by being cohered within the mixed raw material passing through the filter housing 211 can be orderly filtered while passing through the components in a mesh form, and thereby filtering can be performed efficiently.

The materials with a predetermined size or more are removed in the mixed raw material, and only the material with a size of less than the predetermined size may pass the first filter unit 21.

The mesh materials are described as the filter member 212 of the first filter unit 21, but not limited thereto. The materials may be applied in various forms by any material which can filter a filtering target cohered to be a lump.

The filter housing 211 may comprise an opened hole on which a cover (not shown) is disposed to be detachable. When the cover is separated, the filter member 212 may be detached from the filter housing 211 through the opened hole. Accordingly, the mixed raw material in a lump form caught in the filter member 212 can be removed.

The second filter unit 22 comprises a filter housing 221 in which a raw mixed material passes; a holder 222 disposed in the inside of the filter housing 211 to be contacted by the mixed raw material flowing in the housing; a magnetic 223 disposed on the inside of the holder 222 and a magnet 223 generating a magnetic force.

The magnetic force generated by the magnet 223 removes the metallic matters infiltrated in the mixed raw material through a holder 222 allowing the metallic matters to be attached in the outer circumference of the holder, and when the mixed raw material in which the metallic matters are removed is manufactured into a polishing pad through subsequent processes, the damage of a wafer can be reduced.

On the inside of the filter housing 221, a filter space 221a in which a holder 222 is located and a mixed raw material passes are formed.

The mixed raw material may be passed a first filter unit 21.

The mixed raw material may be passed a raw material mixing unit 10.

The filter housing 211 may have a horizontal length longer than the vertical length. The mixed raw material may be moved along the vertical length direction of the filter housing 211.

The filter housing 211 may have a vertical length longer than the horizontal length. The mixed raw material may be moved along the horizontal length direction of the filter housing 211.

An inlet 211b to which the mixed raw material of the filter housing 211 is introduced and an outlet 211c to which the mixed raw material after passing through the filter member 212 may be formed.

On the lower portion of the filter housing 221, the inlet 221b to which the mixed raw material is introduced is formed.

The inlet 221b is connected to the inner circumference of the filter housing 221. And on the upper portion of the filter housing 221, the outlet 221c to which the mixed raw material after passing through the filter space 221a is formed. The mixed raw material emitted to the outlet is the mixed raw material in which metallic matters are substantially removed. As the filter housing 221 is viewed in the front, the inlet 221b and the outlet 221c may face from each other in the opposite angle having a holder 222 therebetween.

The mixed raw material emitted from the raw material mixing unit 10 or a first filter unit 21 and introduced into the inside of the filter housing 221 in a tangent direction causes a warm current while contacted with the holder 222, and thereby makes turning flow overall to move the mixed raw material to the direction of the outlet 221c with a spiral to be emitted to the external of a second filter unit 22.

The holder 222 is disposed in the inside of the filter housing 221.

The holder 222 may be disposed in the vertical direction in the inside of the filter housing 221.

The holder 222 may also be disposed in the horizontal direction in the inside of the filter housing 221.

The holder 222 may be arranged in a plural number. For example, the holder 222 may be arranged in the number of 2 or more, or 2 to 9.

The holder 222 may form a war current while the outer circumference is in contact of the mixed raw material.

For heightening the contact force of the mixed raw material with the holder 222, the length direction of the holder 222 may form a certain angle with the turning flow direction of the mixed raw material. For example, the angle may be an angle of more than 0 and 90 degrees or less, or about 45 degrees to about 90 degrees, or may be substantially a right angle. The inside of the holder 222 may be empty with an accommodating space. An opening hole may be formed on the filter housing 221, and the opening hole may be opened and closed by a detachable cover.

The holder 222 may be connected to the cover 224. Through the detachment of the cover 224, the holder 222 may be taken out to the external of the filter housing 221.

The holder 222 may be directly disposed in the filter housing 221.

The disposed position of the holder 222 may be variously changed depending on the design of a mixing apparatus.

The magnet 223 may be a field magnet and/or an electromagnet.

The magnet may be a neodymium magnet. The magnet may be one having a magnetic force of 10,000 Gauss to 12,000 Gauss. The magnet 223 may be disposed per the holder 222 and arranged to be detachable on the inside.

The mixed raw material passing the filter space 221a may be not directly contacted with a magnet 223. A magnetic force is formed in the circumference of the holder 222, that is, the filter space 221 by the arrangement of the magnet 223. Metallic matters mixed in the mixed raw material flowing with turns in the filter space 221a may be attached to the outer circumference of the holder 222 by the magnetic force of the magnet 223. Accordingly, metallic matters can be separated from the mixed raw material passing through the filter housing 221. The mixed raw material from which metallic matters are separated is emitted to the external of the second filter unit 22 through the outlet 211c.

The holder 222 is separated from the filter housing 221 after separating metallic matters, and the magnet may be detached from the holder 222. By detachment of the magnet 223, the magnetic force is lost in the circumference of the holder 222, and the metallic matters attached in the outer circumference of the holder 222 becomes detached from the outer circumference of the holder 222. Accordingly, the work for removing metallic matters is easy. On the outer circumference of the holder 222, a scraper (made from CORNE and not shown) may be disposed. Through the movement of the scraper, metallic matters attached to the holder 222 may be removed. When the magnet 223 is separated from the holder 222, the movement of the scraper can be allowed, and when the magnet 223 is arranged in the holder 222, the movement of the scraper can be allowed.

The second filter unit 22 generating a magnetic force is located on the rear of a first filter unit 21, and therefore, metallic matters detachable from a mesh material of the first filter unit 21 can also be separated from a second filter unit 22. Accordingly, when the second filter unit 22 generating a magnetic force is located on the rear of the first filter unit, the efficiency according to separation of metallic matters can be increased.

However, to be different from the above description of the mixed raw material emitted from the raw material container 11, which passes the first filter unit 21 and subsequently passes the second filter unit 22, the second filter unit 22 can be arranged earlier than the first filter unit 21, and the mixed raw material emitted from the raw material mixing container 11 can be filtered depending on the size after passing through the second filter unit 22 for separating metallic matters and subsequently passing through the first filter unit 21.

When the mixed raw material passes the filter unit to be physically filtered and/or magnetically filtered and solid matters that can be formed by the foaming agent cohered or incompletely uniformized have a size of a predetermined size or more, the solid matters are removed in addition to removal of metallic matters and thereby a mixed raw material after being filtered can be manufactured.

By comprising the filtered mixed raw material in a curable mixture, a curable mixture in which the infiltration of foreign matters is minimized, and relatively uniform quality can be prepared.

On the other hand, a mixing apparatus of a resin composition for manufacturing a polishing pad according to the present disclosure may further comprises a storing unit 30 in which a mixed raw material maintained in the predetermined size or less after passing through a filter unit 20 to remove metallic matters is and stored. The storing unit 30 may comprise a storage, a container, a tank, or the like that can block the infiltration of foreign matters and protect a mixed raw material from external sources.

(Pad Composition Forming Unit)

A pad composition forming unit 50 is connected to the filter unit 20 and prepares a curable mixture comprising a filtered mixed raw material and a curing agent.

The pad composition forming unit 50 comprises a composition mixing container 51 in which a composition mixing space 511 is disposed; and a and a composition mixing component 52 arranged in the composition mixing container 51.

Composition mixing container may be connected to a filter unit 20 and a supplier for a curing agent 40 through pipes. The composition mixing container 51 may be connected to a storing unit 30 and the supplier for a curing agent 40 through pipes.

The filter unit 20, storing unit 30, and supplier for a curing agent 40 may have a pump or blower arranged thereon. By operation of the pump or blower, a filtered mixed raw material and a curing agent can be supplied to the composition mixing space 511 of the composition mixing container 51. Besides, on the composition mixing container 51, an outlet (now shown) to which a mixed curable mixture is emitted is formed.

The curing agent may comprise one or more compounds selected from the group consisting of aromatic amines, aliphatic amines, aromatic alcohols, and aliphatic alcohols.

For example, the curing agent may be one or more selected from the group consisting of 4,4′-methylenebis(2-chloroaniline) (MOCA), diethyltoluenediamine, diaminodiphenyl methane, diaminodiphenyl sulphone, m-xylylene diamine, isophoronediamine, ethylenediamine, diethylenetriamine, triethylenetetramine, polypropylenediamine, polypropylenetriamine, ethyleneglycol, diethyleneglycol, dipropyleneglycol, butanediol, hexanediol, glycerine, trimethylolpropane, and bis(4-amino-3-chlorophenyl)methane.

The curing agent may be applied in an amount of 1 to 40 parts by weight, 10 to 30 prts by weight, or 20 to 30 parts by weight based on an urethane-based prepolymer of 100 parts by weight.

As needed, the curable mixture may further comprise a reaction speed regulator.

The reaction speed regulator may be a reaction accelerator or a reaction retardatory, and may be a reaction accelerator.

The reaction speed regulator may comprise one or more for example, selected from the group consisting of triethylene diamine (TEDA), dimethyl ethanol amine (DMEA), tetramethyl butane diamine (TMBDA), 2-methyl-triethylene diamine, dimethyl cyclohexyl amine (DMCHA), triethyl amine (TEA), triisopropanol amine (TIPA), 1,4-diazabicyclo(2,2,2)octane, bis(2-methylaminoethyl) ether), trimethylaminoethylethanol amine, N,N,N,N,N″-pentamethyldiethylene triamine, dimethylaminoethyl amine, dimethylaminopropyl amine, benzyldimethyl amine, N-ethylmorpholine, N,N dimethyl aminoethylmorpholine, N,N-dimethylcyclohexyl amine, 2-methyl-2-azanorbornane, dibutyltin dilaurate, stannous octoate, dibutyltin diacetate, diocthyltin diacetate, dibutyltin maleate, dibutyltin di-2-ethylhexanoate, and dibutyltin dimercaptide. Specifically, the reaction speed regulator may be one or more selected from the group consisting of benzyldimethyl amine, N,N-dimethylcyclohexyl amine, and triethyl amine.

The reaction speed regulator may be used in an amount of 0.1 to 2 parts by weight based on an urethane-based prepolymer of 100 parts by weight.

The curable mixture may have a weight average molecular weight of 500 to 3,000 g/mol.

The curable mixture may be a polyurethane resin, and may have a weight average molecular weight of 600 to 2,000 g/mol, or 700 to 1,500 g/mol.

The gelation time ofcurable mixture may be 30 to 300 seconds, or 70 to 180 seconds. The gelation time of curing mixture may be 90 to 110 seconds. In this case, a curing mixture further excellent in the workability can be prepared.

A composition mixing component 52 comprises a motor 521 of a composition mixing container 51; a shaft 522 which may be disposed on the inside of the composition mixing container 51 and connected to an operating axis of the motor 521; and a stirring blade 523 connected to the shaft 522 in the inside of the composition mixing container 51 and mixing a mixed raw material and a curing agent accommodated in the raw material mixing space. The motor 521 may be disposed on the external, and rotates a shaft 522 by a predetermined rotating force.

The stirring blade 523 is rotated in the inside of the composition mixing container 51 by the shaft 522 for a predetermined time and mixes a filtered mixed raw material and a curing agent to prepare a curing mixture.

The composition mixing component 52 may be connected to an ascending and descending device such as an actuator, an electric cylinder (now shown). The composition mixing component 52 may ascend in the composition mixing container 51 and the stirring blade 523 may be out of the inside of the composition mixing container 51.

A raw material mixing mean operated by multiple rotation mean in a raw material mixing unit is moved in the inside of a raw material mixing container and thereby mix a prepolymer and a foaming agent to be uniform. Accordingly, a substantially uniform mixture can be obtained.

The filtered mixed raw material in the state of being maintained for not comprising solid matters with a predetermined size or more and removing metallic matters is obtained when a mixed raw material passes through a filter unit. The filtered mixed raw material and the curing agent are mixed by a composition mixing component in a composition mixing container of a pad composition forming unit and a substantially uniform curing mixture is prepared. The curing mixture forms a polishing pad and improves the quality of a polishing pad itself, and the occurrence of defects such as a scratch of a polished target can be minimized through using the same.

(Manufacturing Method of Polishing Pad)

A manufacturing method of a polishing pad according to another embodiment comprises a filtering operation; a curing mixing operation; and a shaping operation. The manufacturing method of a polishing pad may further comprise a pad making operation after the shaping operation.

The filtering operation is an operation of filtering a mixed raw material comprising a prepolymer and a foaming agent to prepare a filtered mixed raw material.

The detailed description of the prepolymer, foaming agent, and a mixed raw material is overlapped with the above description, and thus the further description is omitted. Also, the filtering process may be performed by the mixed raw material passing through the filter unit described in the above.

The filtering operation may be operated by a physical filtering process and a magnetic filtering process together or respectively. The physical filtering process and the magnetic filtering process may be operated in order.

The curing mixing operation is an operation of preparing a curing mixture comprising the filtered mixed raw material and a curing agent.

The detailed description of the curing agent and another additive is overlapped with the above, and thus the further description is omitted.

The mixing process of a curing mixture may be operated by using the pad composition forming unit described in the above. In such a case, a curing mixture can be more effectively mixed.

The shaping operation is an operation of putting the curing mixture into a mold to prepare a shaped body.

The mold (not shown) may comprise a mold which can form a shaped body having a regular thickness and shape, and the shaped body formed by the mold may be applied by itself as a polishing layer, or may be applied after passing through an additional shaping machining as a polishing layer.

An inert gas may be injected in the shaping operation. The inert gas may be injected in the process of reacting a curing mixture and may form pores in a shaped body.

The inert gas is not specially limited in the type, if the gas is not involved in the reaction between a prepolymer and a curing agent. For example, the inert gas may be one or more selected from the group consisting of nitrogen gas (N₂), argon gas (Ar), and helium (He).

The inert gas may be injected in an amount of 20 to 35 volume % based on a total volume of a curing mixture. The inert gas may be injected in an amount of 20 to 30 volume % based on a total volume of a curing mixture.

A packing operation may be further comprised after the shaping operation.

The packing operation is an operation of packing a shaped body. The shaped body or polishing layer may be stored or moved by being packed in an automated way to have a unit quantity before being applied to chemical mechanical polishing.

The pad making operation is an operation of preparing a polishing pad comprising at least some of the shaped body as a polishing layer.

The polishing pad comprises a polishing layer as a top pad.

The polishing layer may have an average pore size of 10 to 30 μm. Applying the polishing layer having such an average pore size is preferable to improve the polishing efficiency of a polishing pad.

The polishing layer may be a polyurethane in the shape of a foaming body with an area rate of 36 to 44%.

When a polyurethane polishing layer in the shape of a foaming body with such a characteristic is applied as a top pad, it is possible to polish a wafer efficiently.

The polishing layer may be applied by one having a shore D hardness of 50 to 65, and in this case, the efficiency of polishing can be increased.

The polishing layer may be applied by one having a tensile strength of 15 to 35 N/mm², and in this case, the efficiency of polishing can be further increased.

The polishing layer may be applied by one having an elongation of 110 to 230%, and in this case, the efficiency of polishing can be further increased.

The polishing layer may be applied by one having a thickness of 1.5 to 3 mm, and in this case, the efficiency of polishing can be increased.

The polishing layer in the shape of a foaming body comprises multiple pores, and the average size of the pores may be about 30 μm or less, or about 15 μm to about 25 μm.

The polished target polished to be a polishing layer in the shape of a foaming body has a low defect characteristic, and in detail, the polished target may have a characteristic of three or less defects, and one or less scratch based on the entire polished surface of the polished target.

The polishing pad may further comprise a sub pad under the top pad/The sub pad may be a suede type or a felt type.

The sub pad may have an Asker C hardness of 60 to 90.

The sub pad may have a thickness of 0.5 to 1 mm.

An adhesive layer may be disposed between the top pad (polishing layer) and the sub pad.

The top pad (polishing layer) and the sub pad may be attached through a hot-melt adhesive layer.

A rubber-based bond may be applied to the other surface of the sub pad.

The rubber-based bond may have another surface where a film like a PET film is located. Another rubber-based adhesive body layer may be further located on the film.

The other surface of the sub pad may be attached to a plate of a polishing device through a rubber-based bond.

A polishing pad manufactured by the present disclosure improves the dispersion degree of a prepolymer and a foaming agent to prevent the occurrence of lump of a solid foaming agent, and thereby can improve the stability of the manufacture of a polishing pad. Additionally, when polishing applied with a polishing pad proceeds, it is easy to secure a storable stability and micro fluidity of slurry particles, and thereby polishing can be made with a more excellent quality.

(Classifying Refinement of Solid Foaming Agent)

A solid foaming agent may be classified and refined by a classifying refinement method of the same.

Classifying refinement may be operated by a classifying refinement method comprising a classifying operation and a filtering operation.

The classifying operation is an operating of classifying the solid foaming body ascended by a flowing gas supplied to a classifying space into first microspheres and second microspheres depending on the descending speed thereof.

The flowing gas may be a dry air or nitrogen gas, and the first microspheres may have a moisture regain of 3 wt % or less.

The filtering operation is an operation in which the first microspheres are separated and refined from metallic matters by a magnetic filer while passing through a filter unit, to prepare a classified and refined solid foaming agent.

When the first microspheres that are controlled in the moisture regain and classified for the size and/or weight to be in a certain range by the classifying operation are applied as the solid foaming agent, the size and distribution of pores in a remove rate can be further well controlled, and because metallic foreign matters are removed by the magnetic filter, the polishing quality can also be further improved.

A classifying refinement apparatus for a solid foaming agent comprises a classifying unit which classifies the supplied solid foaming agent into first microspheres and second microspheres, a storing unit connected to the classifying unit for flowing of the classified first microspheres to be stored and emitted, and a filter unit arranged in a moving route of the solid foaming agent or first microspheres to separate metallic matters from a filtering target comprising the solid foaming agent or the first microspheres.

The filter unit may comprise a filter housing which has a filter space for flowing of the solid foaming agent or the first microspheres formed therein, a filter cover arranged in the filter housing to be detachable for opening and closing the filter space, and a filter component arranged in the filter space and generating a magnetic force.

The metallic matters may be attached to the filter component by the magnetic force.

The filter component may comprise a holder unit disposed in the filter space, and a magnet arranged in the holding unit.

The metallic matters may be attached to the holder unit to be removed from the filtering target.

A filter inlet connected to the filter space is formed in the filter housing, and the filter inlet may be connected to the circumference of the filter space in a tangent direction.

The filtering target may move with generating an eddy while contacted with the filter component in the filter space.

A filter outlet connected to the filter space to emit the filtering target in which metallic matters are removed may be formed on the filter housing or the filter cover.

The filter cover may be disposed on an opening surface of the filter housing, and the filter outlet may be formed on the filter cover.

The filtering target may be emitted to the external of the filter housing through the filter outlet while contacted to the filter component in the filter space and ascending gradually.

The solid foaming agent may have a density of 100 kg/m³ or less.

Hereinafter, the detailed embodiments will be described in further detail. The example embodiments below are no more than examples, and the scope of the present application is not limited thereto.

### Manufacture Example

1) Classification of Solid Foaming Agent

A solid foaming agent (Expancel with an average particle size of 5.5 μm, a moisture regain of 3.5%, and a density of 47.2 kg/m³) was classified through a classifying refinement method.

As Sample 1, one processed by classification only without applied with a magnetic filter was disclosed, and nitrogen gas retrieved after operation of classification and refinement was disclosed as Sample 2, Sample 3, and Sample 4, respectively.

A magnetic filter (a magnetic force of 10,000 G) was disposed between a storing unit of the rear of a classifying unit and the classifying unit, to perform an experiment. The vibration rotation was performed by operating a vibration rotary machine equipped in an apparatus, and the vibration was added to be 10 to 100 Hz. Whether the vibration rotation was applied was disclosed in Table 1 below.

The moisture regain was measured by checking the increase and decrease in the weight when 1 to 3 g per sample was weight by using HX204 (Mettler Toledo corporation) and heated for 1 minute and 30 seconds at a temperature of 120° C.

The density was measured after a sample was placed in a cell of 10 cc by using AccuPyc 1340 (Micromeritics corporation) and measured for the weight.

The average particle size was measured by dispersing in an ethanol solvent through S3500+ (Microtrac corporation).

TABLE 1

| | Sample 1 | Sample 2 | Sample 3 | Sample 4 |
|---|---|---|---|---|
| | Not | Nitrogen | Nitrogen | Nitrogen |
| Flowing Gas | Applied | Gas | Gas | Gas |
| Whether Vibration | ◯ | ◯ | ◯ | ◯ |
| Was Applied | | | | |
| Whether Magnetic | X | X | ◯ | ◯ |
| Filter Was Present | | | | |
| Moisture Regains | 3.5 | 1 | 1.1 | 1 |
| After Processes | | | | |
| (wt %) | | | | |
| Density of Solid | 47.2 | 45.2 | 45.2 | 45.1 |
| Foaming Agent | | | | |
| (kg/m³) | | | | |
| Properties | | | | |
| Average Particle | 35.5 | 31.3 | 31.5 | 31 |
| Size (μm) | | | | |
| Removal Rate of | 0 | 0 | 98 | 106 |
| Metal (mg/Kg) | | | | |

With reference to the Table 1, it was confirmed that the moisture regains after processes were reduced in Sample 2, Sample 3, and Sample 4 compared to Sample 1, and for the average particle size or the density, it was confirmed that the cases of refined and classified examples had a lower value.

For the removal rate of metal, the removal rate of a metal removed by applying a magnetic filter was shown as respectively 98 mg/Kg and 106 mg/Kg in Sample 3 and Sample 4, and it could be confirmed that metallic foreign matters were considerably removed through the magnetic filter.

2) Manufacture of Polishing Layer

An urethane-based prepolymer (NCO % of 9.1 wt % and weight average molecular weight of 1,200 g/mol) and the solid foaming agent classified in the above were put into a raw material mixing unit, and mixed while a first operating mean and a second operating mean were spun to have the same rotation number (rpm) as specificized in Table 2 below, thereby manufacturing a mixed raw material.

The mixed raw material was prepared by passing through a mesh filter with 70 mesh (the interval size of 250 μm) and a magnetic filter in order, or not passing through them depending on samples.

A curing agent (bis(4-amino-3-chlorophenyl)methane)), an inert gas (N₂), a reaction speed regulator (tertiary amine-based compound), and the like were put into a pad composition forming unit and mixed to prepare a curing mixture.

The solid foaming agent was applied as disclosed in Table 2 below by 2 parts by weight based on the urethane-based prepolymer of 100 parts by weight. The curing mixture was injected into a mold (width of 1,000 mm, length of 1,000 mm, and height of 3 mm) after being mixed and a shaped body was obtained. Through the processes of grinding the shaped body with a surface grinder and grooving it by using a tip, polishing layers with the average thickness of 2 mm were respectively manufactured.

TABLE 2

| | Example | Example | Example | Example | Example | Example | Example |
|---|---|---|---|---|---|---|---|
| | 1 | 2 | 3 | 4 | 5 | 6 | 7 |
| The Rotation | 100 | 100 | 100 | 100 | 100 | 100 | 100 |
| Speed of First | | | | | | | |
| Operating Mean | | | | | | | |
| of the Raw | | | | | | | |
| Material Mixing | | | | | | | |
| Unit (rpm) | | | | | | | |
| The Rotation | 100 | 500 | 1000 | 2000 | 100 | 100 | 100 |
| Speed of Second | | | | | | | |
| Operating Mean | | | | | | | |
| of the Raw | | | | | | | |
| Material Mixing | | | | | | | |
| Unit (rpm) | | | | | | | |
| The Ratio of | 1:1 | 1:5 | 1:10 | 1:20 | 1:1 | 1:1 | 1:1 |
| Rotation Speed | | | | | | | |
| (First Operating | | | | | | | |
| Mean: Second | | | | | | | |
| Operating Mean) | | | | | | | |
| Whether Mesh | Applied | Applied | Applied | Applied | Applied | Applied | Applied |
| Filter Was | | | | | | | |
| Applied to the | | | | | | | |
| Rear of the Raw | | | | | | | |
| Material Mixing | | | | | | | |
| Unit | | | | | | | |
| Whether Mesh | Applied | Applied | Applied | Applied | Applied | Applied | Applied |
| Filter Was | | | | | | | |
| Applied to the | | | | | | | |
| Rear of the Raw | | | | | | | |
| Material Mixing | | | | | | | |
| Unit | | | | | | | |
| Applied Solid | Sample | Sample | Sample | Sample | Sample | Sample | Sample |
| Foaming Agent | 4 | 4 | 4 | 4 | 1 | 2 | 3 |

The polishing layers were respectively attached to felt type sub pads with the thickness of 1.1 mm and the hardness (shore C) of 70 to prepare polishing pads. These polishing pads were applied to Evaluation Example below.

### Evaluation Example

1) Property Measurement of Polishing Layer

Hardness: Shore D hardness was measured, a polishing pad was cut into the size of 2 cm×2 cm (thickness of 2 mm) and leaved for 16 hours in the environment of a temperature of 23±2° C. and a humidity of 50±5%. Thereafter, the hardness of the polishing pad was measured by using a hardness meter (D type hardness meter).

Density: A polishing pad was cut into a rectangular of 4 cm×8.5 cm (thickness of 2 mm) and leaved for 16 hours in the environment of a temperature of 23±2° C. and a humidity of 50±5%. The density of the polishing pad was measured by using a density meter.

Tensile Characteristic: Test Samples were obtained in five spots within a pad to have the size of a width of 150 mm and a length of 10 mm, the tensile strength and the elongation were measured by using JIS B 7721 tensile tester.

2) Measurement of Pore Properties

Average Diameter of Pores: A polishing pad was cut into a square of 2 cm×2 cm (thickness of 2 mm), and after that observed by being enlarged to be 100 times by using Scanning Electron Microscope (abbreviated as SEM and available from JEOL corporation). The entire pore diameter was measured from the image obtained by using an image analysis software, and thereby the quantity, the size, the area rate, and the like were calculated.

3) Measurement of Polishing Characteristics

Measurement of Remove Rate:

By using CMP polishing apparatus, a silicon wafer with a diameter of 300 mm in which a silicon oxide film had been formed, which was produced by TEOS-plasma CVD method, was equipped, and set on a plate to which the porous polyurethane polishing pad had been attached, by facing the silicon oxide film surface of the silicon wafer to the bottom.

The polishing load was adjusted to be 4.0 psi and a polishing pad was rotated at 150 rpm, simultaneously calcination silica slurry was injected in a rate of 250 ml/minute on the polishing pad and a plate was rotated for 60 seconds at 150 rpm, and thereby a silicon oxide film was polished.

After polishing, the silicon wafer was detached from a carrier, equipped in a spin dryer to be cleaned with deionized water (DIW), and dried for 15 seconds with air. The dried silicon wafer was measured for the film thickness variation before and after polishing by using a reflectometer (manufacturer: Kyence corporation, model: SI-F80R) and the remove rate was calculated by Equation below.

Remove Rate=Polishing Thickness of Silicon Wafer (A)/Polishing Time (60 seconds)

Measurement of Defects: The number of defects within a silicon wafer.

By using CMP polishing apparatus, polishing was performed as the same as the measuring method for remove rate. After polishing, each silicon wafer was moved by a cleaner and cleaned for 10 seconds by respectively using HF of 1 wt %, H₂NO₃ of 1 wt %, and deionized water (DIW). Thereafter, the silicon wafer was moved by a spin dryer, cleaned with deionized water and dried for 15 seconds with nitrogen.

Dried silicon wafer was measured for the number of defects after being polishing by suing a defect meter (manufacturer Tenkor corporation, model: XP+). The defects mean minute scratches or chatter marks. As the result evaluated by using a silicon wafer with a diameter of 300 mm, the number of defects was the result evaluated based on the area of 70685.83 mm².

TABLE 3

| | Example | Example | Example | Example | Example | Example | Example |
|---|---|---|---|---|---|---|---|
| | 1 | 2 | 3 | 4 | 5 | 6 | 7 |
| Properties of Polishing Layer: | 2.01 | 2.01 | 2.01 | 2.01 | 2.01 | 2.01 | 2.01 |
| Thickness (mm) | | | | | | | |
| Properties of Polishing Layer: | 58.1 | 57.8 | 57.6 | 57.2 | 58.5 | 58.3 | 58.2 |
| Hardness (Shore D) | | | | | | | |
| Properties of Polishing Layer: | 0.8 | 0.8 | 0.8 | 0.8 | 0.8 | 0.8 | 0.8 |
| Density (g/cm³) | | | | | | | |
| Properties of Polishing Layer: | 31.0 | 30.5 | 29.8 | 29.5 | 32.3 | 31.2 | 30.2 |
| Tensile Strength (N/mm²) | | | | | | | |
| Properties of Polishing Layer: | 120 | 119 | 118 | 117 | 123 | 121 | 120 |
| Elongation (%) | | | | | | | |
| Properties of Pores: | 25 | 25 | 25 | 25 | 25 | 25 | 25 |
| Numerical Average | | | | | | | |
| Dimater (um) | | | | | | | |
| Properties of Pores: Quantity | 310 | 315 | 320 | 320 | 318 | 319 | 315 |
| (Number/0.3 cm³) | | | | | | | |
| Polishing Characteristics: | 2100 | 2013 | 2131 | 2212 | 2003 | 2054 | 2083 |
| Remove Rate (A/min) | | | | | | | |
| Defects (Number) | 10 | 5 | 4 | 1 | 8 | 7 | 5 |
| Scratch (Number) | 5 | 2 | 1 | 0 | 6 | 4 | 3 |

With reference to Table 2 and Table 3 above, a difference is shown in the result of defects of scratches depending on the degree of preprocessing of the applied solid foaming agent. However, though Examples 1 to 4 applied the solid foaming agent passed through the same preprocessing, there are great differences in the elongation, pore properties, remove rate, and the like depending on the ratio of rotation speeds of a first operating mean and a second operating mean. The cases of Example 3 and Example 2 with relatively great ratios of rotation speed exhibited a considerably large quantity of pore properties. It is thought that because the quantity of pore properties is shown to be considerably large and substantially uniform mixing is performed in the above case, a cohered foaming agent is not removed and dispersed well by a mesh filter and the like, thereby showing a relatively large quantity of pores. On the other hand, the elongation thereof has been shown to be somewhat lowered, and this is thought to be a mechanical deformation shown in some of polymer chains by considerably strong rotation. For the remove rate, when Example 3 and Example 4 in which the number of surface pores were observed to be substantially identical were compared, Example 4 showed the most excellent result because it showed more improved remove rate and lower degrees of defects and scratches.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for mixing a resin composition for manufacturing a polishing pad comprising:
a raw material mixer preparing a mixed raw material comprising a prepolymer and a foaming agent;
a filter connected to the raw material mixer for filtering the mixed raw material; and
a pad composition mixer connected to the filter to prepare a curable mixture comprising the mixed raw material after being filtered and a curing agent,
wherein the raw material mixer comprises a plurality of rotators having different rotation speeds.

2. The apparatus of claim 1, wherein the filter comprises a first filter for filtering the mixed raw material depending on a size of the mixed raw material.

3. The apparatus of claim 1, wherein the filter comprises a second filter for separating metallic matters from the mixed raw material.

4. The apparatus of claim 2, wherein the first filter comprises:
a first filter housing, in which the mixed raw material moves; and
a filtering wall disposed in the filter housing, through which the mixed raw material passes,
wherein the filtering wall allows the mixed raw material in a predetermined size or less to be passed.

5. The apparatus of claim 3, wherein the second filter comprises:
a second filter housing, in which the mixed raw material passes;
a holder disposed in the second filter housing and in contact with the mixed raw material passing therethrough; and
a magnet disposed in an inner portion of the holder and generating a magnetic power,
wherein the metallic matters are attached to an outer circumference of the holder by the magnetic power and thereby removed from the mixed raw material.

6. The apparatus of claim 5,
wherein in an inner portion of the second filter housing, a filter space, in which the holder is located, is disposed,
wherein in an outer circumference of the lower portion of the second filter housing, an inlet to which the mixed raw material is introduced to the filter space, is disposed in a tangent direction of the outer circumference, and
wherein in the outer circumference of an upper portion of the second filter housing, an outlet for emitting the mixed raw material, which is separated from the metallic matters after passing through the filter space, is disposed.

7. The apparatus of claim 6, wherein the outlet is arranged side by side with the tangent direction of the outer circumference.

8. The apparatus of claim 6, wherein the inlet and the outlet face together in an opposite angle having the holder therebetween.

9. The apparatus of claim 5, wherein the second filter further comprises a cover combined with the second filter housing to be separatable and connected to the holder.

10. The apparatus of claim 1, wherein the raw material mixer comprises:
a mixing container, in which a raw material mixing space is disposed; and
a raw material stirrer disposed in the raw material mixing space and may be moved by the plurality of rotators,
wherein the raw material mixer mixes the prepolymer and the foaming agent, accommodated in the raw material mixing space, and disperses the foaming agent in the mixed raw material.

11. The apparatus of claim 10,
wherein the plurality of rotators comprise a first operating component and at least one second operating component,
wherein the raw material mixer comprises:
a rotating body connected to the first operating component to be rotatable, in which the at least one second operating component is disposed; and
at least one raw material mixing component connected to the at least one second operating component to be rotatable,
wherein the at least one raw material mixing component is rotated by the at least one second operating component.

12. The apparatus of claim 11,
wherein the raw material mixing component comprises:
a shaft connected to an operating axis of the at least one second operating component; and
a stirring blade accommodated in the raw material mixing space.

13. The apparatus of claim 12, wherein the stirring blade comprises a helical type stirring blade.

14. An apparatus for mixing of a resin composition for manufacturing a polishing pad comprising:
a raw material mixer preparing a mixed raw material comprising a prepolymer and a foaming agent;
a filter connected to the raw material mixer for filtering the mixed raw material; and
a pad composition mixer connected to the filter and prepares a curable mixture comprising the mixed raw material after being filtered and a curing agent,
wherein the raw material mixer comprises:
a raw material mixing container, in which a raw material mixing space is disposed;
a shaft connected to an operating axis of an operator and disposed in the raw material mixing space; and
a stirring blade connected to the shaft and rotating,
wherein the stirring blade mixes the prepolymer and the foaming agent supplied to the raw material mixing space and disperses the foaming agent in the mixed raw material while rotating.

15. The apparatus of claim 14, wherein the filter comprises a first filter for filtering the mixed raw material depending on a size of the mixed raw material.

16. The apparatus of claim 14, wherein the filter comprises a second filter for separating metallic matters from the mixed raw material.

17. A method for of manufacturing a polishing pad comprising:
filtering a mixed raw material comprising a prepolymer and a foaming agent to prepare a mixed raw material after being filtered;
preparing a curable mixture comprising the mixed raw material after being filtered and a curing agent; and
putting the curable mixture into a mold and preparing a shaped body, thereby manufacturing a polishing pad comprising at least some of the shaped body as a polishing layer,
wherein the filtering comprises a filtering process to which a magnetic filter is applied.

18. The method of claim 17, wherein the foaming agent comprises a solid foaming agent, and the solid foaming agent is one classified and refined.

19. The method of claim 17, wherein the foaming agent comprises a solid foaming agent having a moisture regain of 3 wt % or less.
